(19) United States
(12) Patent Application Publication
(10) Pub. No.: US 2013/0233693 A1
(43) Pub. Date: Sep. 12, 2013

(54) Apparatus for Recovering Products Using Adsorption Separation and Fractionation

(71) Applicant: UOP LLC, Des Plaines, IL (US)

(72) Inventors: Jason T. Corradi, Arlington Heights, IL (US); James W. Harris, Palatine, IL (US)

(73) Assignee: UOP LLC, Des Plaines, IL (US)

(21) Appl. No.: 13/775,460

(22) Filed: Feb. 25, 2013

Related U.S. Application Data
(60) Provisional application No. 61/609,254, filed on Mar. 9, 2012.

(51) Int. Cl. B01D 3/14

(52) U.S. Cl. CPC B01D 3/14
USPC 202/168

(57) ABSTRACT

An apparatus according to various approaches includes separating a component from a feed stream using adsorption separation. The process further includes directing one of the extract stream and the raffinate stream to a high pressure distillation column. In addition, the process includes pumping the one of the extract stream and the raffinate stream to increase the pressure in the stream to flow the one of the extract stream and the raffinate stream into an inlet of the distillation column.

### CROSS-REFERENCE TO RELATED APPLICATION

This application claims the benefit of U.S. Provisional Application No. 61/609,254 which was filed on Mar. 9, 2012.

### FIELD OF THE INVENTION

The subject invention relates to an apparatus for recovering products using the adsorptive separation of a component from a feed stream and fractionation. More specifically, the invention relates to an apparatus and process for the separation of a preferentially adsorbed component using one or more pumps for pumping a stream from an adsorption separation unit to a fractionation column.

### BACKGROUND OF THE INVENTION

Para-xylene and meta-xylene are important raw materials in the chemical and fiber industries. Terephthalic acid derived from para-xylene is used to produce polyester fabrics and other articles which are in wide use today. Meta-xylene is a raw material for the manufacture of a number of useful products including insecticides and isophthalic acid. Ortho-xylene is used to produce phthalic anhydride, which supplies high-volume but relatively mature markets. Ethylbenzene generally is present in xylene mixtures and is occasionally recovered for styrene production, but is usually considered a less-desirable component of C8 aromatics. One or a combination of adsorptive separation, crystallization and fractional distillation have been used to obtain these xylene isomers, with adsorptive separation capturing a great majority of the market share of newly constructed plants for the dominant para-xylene isomer.

Among the aromatic hydrocarbons, the overall importance of xylenes rivals that of benzene as a feedstock for industrial chemicals. Xylenes and benzene are produced from petroleum by reforming naphtha but not in sufficient volume to meet demand, thus conversion of other hydrocarbons is necessary to increase the yield of xylenes and benzene. Often toluene is de-alkylated to produce benzene or selectively disproportionated to yield benzene and C8 aromatics from which the individual xylene isomers are recovered.

An aromatics complex flow scheme has been disclosed by Meyers in the Handbook of Petroleum Refining Processes, 2d. Edition in 1997 by McGraw-Hill, and is incorporated herein by reference.

Aromatics complexes typically include one or more adsorptive separation vessels for carrying out one or more adsorptive separations to separate one or more of the xylene isomers a feed stream including the desired isomer and one or more other isomers. Processes for adsorptive separation are widely described in the literature. For example, a general description directed to the recovery of para-xylene was presented at page 70 of the September 1970 edition of Chemical Engineering Progress (Vol. 66, No 9). There is a long history of available references describing useful adsorbents and desorbents, mechanical parts of a simulated moving-bed system including rotary valves for distributing liquid flows, the internals of the adsorbent chambers and control systems. The principle of using a simulated moving bed to continuously separate the components of a fluid mixture by contact with a solid adsorbent is as set forth in U.S. Pat. No. 2,985,589. U.S. Pat. No. 3,997,620 applies the principle of the simulated moving bed to the recovery of para-xylene from a feed stream containing C₈ aromatics, and U.S. Pat. No. 4,326,092 teaches meta-xylene recovery from a C₈-aromatics stream.

Adsorptive separation units processing C₈ aromatics generally use a simulated countercurrent movement of the adsorbent and the feed stream. This simulation is performed using established commercial technology wherein the adsorbent is held in place in one or more cylindrical adsorbent chambers and the positions at which the streams involved in the process enter and leave the chambers are slowly shifted along the length of the beds. A typical adsorptive separation unit is illustrated in FIG. 6 and includes at least four streams (feed, desorbent, extract and raffinate) employed in this procedure and the location at which the feed and desorbent streams enter the chamber and the extract and raffinate streams leave the chamber are simultaneously shifted in the same direction at set intervals. Each shift in location of the transfer points delivers or removes liquid to or from a different bed within the chamber. In general, to simulate countercurrent movement of the adsorbent relative to the fluid stream within the chamber, the streams are shifted in the general direction of fluid flow, i.e. the downstream direction, within the chamber to simulate the solid adsorbent moving in the opposite, i.e. upstream, direction.

The art recognizes that the presence of residual compounds in the transfer lines can have detrimental effects on a simulated-moving-bed process. U.S. Pat. Nos. 3,201,491; 5,750,820; 5,884,777; 6,004,518; and 6,149,874 teach the flushing of the line used to deliver the feed stream to the adsorbent chamber as a means to increase the purity of the recovered extract or sorbate component. Additional flushing streams may also be present in an adsorptive separation process or unit in addition to the four primary lines discussed above.

Aromatics complexes producing xylenes are substantial consumers of energy, notably in distillation/fractionation operations to prepare feedstocks and separate products from conversion processes. The separation of xylenes from heavy aromatics in particular offers substantial potential for energy savings.

Recently, energy efficiency of aromatics complexes has been achieved by modifications to traditional aromatics flowschemes. Energy conservation in such processes not only reduces processing costs but also addresses current concerns about carbon emissions. U.S. patent applications Ser. Nos., 12/868,286; 12/868,309; 12/868,179; and 12/868,123, which are each incorporated herein by reference in their entirety, provide processes and apparatus for energy conservation in heavy-hydrocarbon distillation, including separations of xylene isomers via adsorptive separation.

The systems described in the above identified applications derive energy efficiency at least in part from heat integration between fractionation columns To this end, one or more distillation columns within the aromatics complex operate at different pressures relative to the previous complex design and relative to one another, including, in some approaches the extract and/or raffinate distillation columns It should be noted that distillation and fractionation are used interchangeably herein. There may also be more heat exchangers at various locations in the complex, including an extract column feed line. More particularly, by operating the distillation columns at different pressures, heat from a column can then be used to provide heat to reboil one or more other columns In some approaches, direct heat exchange may be utilized. For example, pressurized extract distillation column may provide heat to reboil one or more of benzene fractionation columns and finishing columns A pressurized raffinate distillation column may provide heat to reboil one or more of a reformate splitter, a toluene distillation column, and a deheptanizer. In the same or other approaches, indirect heat-exchange may also be provided through the generation of medium-pressure steam For example, the high-pressure xylene column 133 may provide heat to reboil the low-pressure xylene column 130 and extract column 152, which in turn reboils the benzene column 123 and finishing column 155.

In this regard, it has been found that although operating the extract distillation column and/or raffinate distillation column at elevated pressures, along with including additional heat exchangers in the extract and/or raffinate column feed lines can provide energy savings, the elevated pressure is often too high for the pressure differential between the adsorption separation unit and the fractionation column to provide the driving mechanism for moving the fluid from the adsorption separation unit, through a line or conduit, and into the fractionation column where the adsorption separation unit is operated under traditional conditions and pressures. The operating pressure of the adsorption section is traditionally set to ensure the process fluid in the chambers remains in liquid phase and such that outgoing streams such as extract and raffinate can be pressured into the downstream distillation columns without need for pumps. These flows must be carefully controlled at all times for proper operation of the adsorption separation unit. Because a pressure differential between the adsorptive separation unit and the extract and raffinate distillation columns provides the driving mechanism for moving the extract streams and raffinate streams thereto, the increased pressure in these columns can affect the proper flow of the extract and raffinate streams. In this regard the pressure in the adsorption separation unit must be sufficiently higher than the traditional operating pressure to provide a pressure differential for driving the fluid flow, taking into account pressure losses that the stream of fluid undergoes between exiting the adsorption separation unit and flowing through the line or conduit connecting the adsorption separation unit and the fractionation column and any other equipment encountered along the line.

To maintain the traditional design of the adsorption section in the new schemes, the operating pressures of the adsorption separation chambers must be increased. While current pumps at the extract and raffinate column bottoms as shown in FIG. 6, and other pumps throughout current designs, can be modified in order to produce this increased pressure, this has been found to be undesirable for at least the following reasons. First, this increases the pressure throughout the aromatics complex, including the adsorptive separation unit and chambers. Because the adsorptive separation unit is carefully calibrated to provide maximum separation of the preferred xylene isomer, this change in operating pressure can have a negative impact on the operation of the adsorptive separation chamber. Second, increasing the pressure in the adsorption separation chambers and throughout the system comes with its own energy penalty that can offset the energy benefit gained by the new schemes discussed above. Third, fabricating the equipment able to withstand the increased pressures and the foundations necessary to support the reinforced equipment increases the material and difficulty present in fabrication, and thus increases the capital cost of the aromatics complex.

Finally, some simulated adsorptive separation units include a rotary valve for directing fluids into different ports of the adsorptive separation chambers, as described for example in U.S. Pat. Nos. 3,040,777 and 3,422,848, for example, which are incorporated herein by reference. These rotary valves include a Rotary valve seal sheet. It has been found that the life of the seal sheet decreases under higher operating pressures within the adsorptive separation chamber.

### BRIEF DESCRIPTION OF THE DRAWINGS

FIG. 1 is a simplified diagram of an aromatics complex and process with energy conservation;

FIG. 2 shows the application of energy conservation in the distillation of C8 aromatics from heavy aromatics;

FIG. 3 illustrates examples of specific units within an aromatics complex in which direct heat exchange could achieve energy savings;

FIG. 4 illustrates an aromatics complex in which some of the energy-savings concepts described herein are applied as a supplement or substitute for other energy savings;

FIG. 5 illustrates the generation of steam from specific units within an aromatics complex;

FIG. 6 is a simplified diagram of a traditional aromatics complex including an adsorption separation unit and raffinate and extract fractionation columns;

FIG. 7 is an exploded view of a rotary valve with the valve head removed;

FIG. 8 is a simplified diagram of an aromatics complex including at least one pump between the adsorption separation unit and a fractionation column; and

FIG. 9 is the simplified diagram of the aromatics complex of FIG. 8 illustrating multiple pump systems.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION AND PREFERRED EMBODIMENTS

The feedstream to the present process and apparatus generally comprises alkylaromatic hydrocarbons of the general formula C6H(6−n)Rn, where n is an integer from 0 to 5 and each R may be CH3, C2H5, C3H7, or C4H9, in any combination. The aromatics-rich feed stream to the process of the invention may be derived from a variety of sources, including without limitation catalytic reforming, steam pyrolysis of naphtha, distillates or other hydrocarbons to yield light olefins and heavier aromatics-rich byproducts (including gasoline-range material often referred to as “pygas”), and catalytic or thermal cracking of distillates and heavy oils to yield products in the gasoline range. Products from pyrolysis or other cracking operations generally will be hydrotreated according to processes well known in the industry before being charged to the complex in order to remove sulfur, olefins and other compounds which would affect product quality and/or damage catalysts used in processing such feedstocks. Light cycle oil from catalytic cracking also may be beneficially hydrotreated and/or hydrocracked according to known technology to yield products in the gasoline range; the hydrotreating preferably also includes catalytic reforming to yield the aromatics-rich feed stream. If the feed stream is catalytic reformate, the reformer preferably is operated at high severity to achieve high aromatics yield with a low concentration of nonaromatics in the product.

The process and apparatus in accordance with the invention includes an adsorption separation unit 150 for separating components of a hydrocarbon stream. Adsorptive separation is applied to the recovery of a variety of hydrocarbon and other chemical products. Chemical separations using this approach which have been disclosed include the separation of mixtures of aromatics into specific aromatic isomers, of linear from nonlinear aliphatic and olefinic hydrocarbons, of either paraffins or aromatics from a feed mixture comprising both aromatics and paraffins, of chiral compounds for use in pharmaceuticals and fine chemicals, of oxygenates such as alcohols and ethers, and of carbohydrates such as sugars. Aromatics separations include mixtures of dialkyl-substituted monocyclic aromatics and of dimethyl naphthalenes.

A major commercial application, which forms the focus of the prior references and of the following description of the present invention without so limiting it, is the recovery of para-xylene and/or meta-xylene from mixtures of C₈ aromatics, due to typically high purity requirements for these products. Such C₈ aromatics usually are derived within an aromatics complex by the catalytic reforming of naphtha followed by extraction and fractionation, or by transalkylation or isomerization of aromatics-rich streams in such complexes; the C₈ aromatics generally comprise a mixture of xylene isomers and ethylbenzene. Processing of C₈ aromatics using simulated-moving-bed adsorption generally is directed to the recovery of high-purity para-xylene or high-purity meta-xylene; high purity usually is defined as at least 99.5 wt.-% of the desired product, and preferably at least 99.7 wt.-%. It should be understood, that while the following detailed description focuses on the recovery of high-purity para-xylene from a mixed xylene and ethylbenzene stream, the invention is not so limited, and is also applicable for separating other components from a stream comprising two or more components. As used herein, the term preferentially adsorbed component refers to a component or components of a feed stream that are more preferentially adsorbed than one or more non-preferentially adsorbed components of the feed stream.

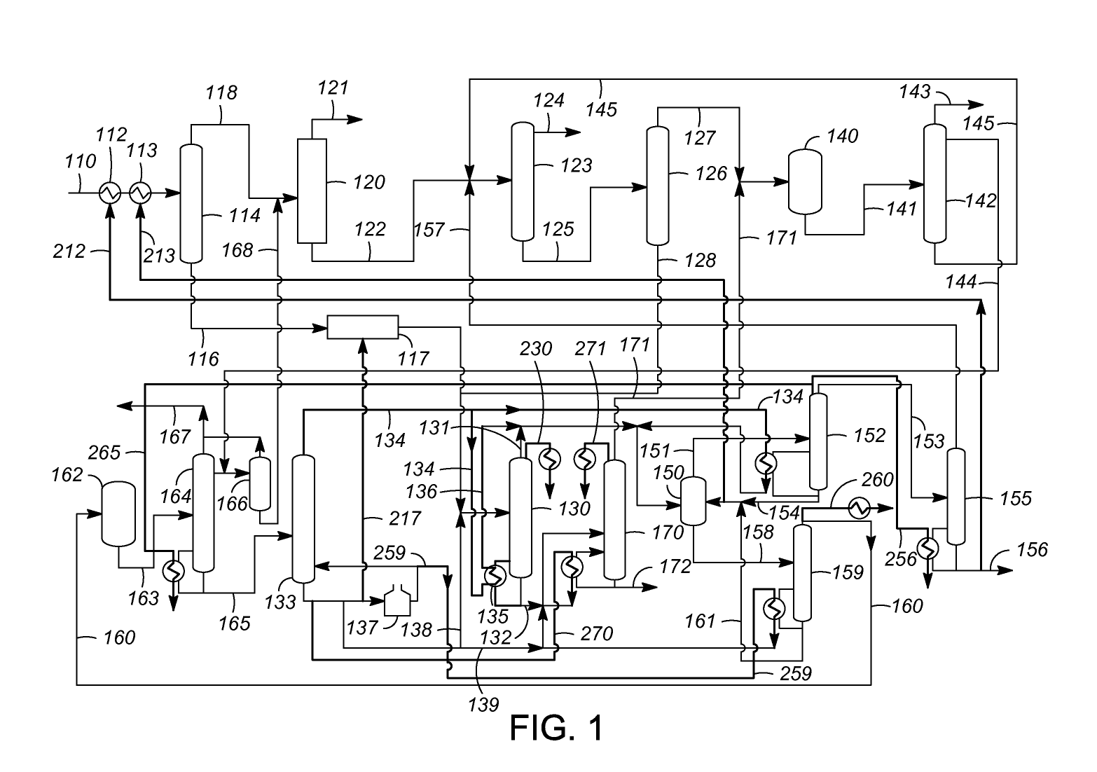

FIG. 1 is an example energy-efficient aromatics complex in accordance with various embodiments of the present invention. The feed stream is passed via line or conduit 110 via heat exchangers 112 and 113, which raise the temperature of the feed stream, to reformate splitter 114. The heat exchange is supplied via conduits 212 and 213 respectively from the net para-xylene product and the recovered desorbent from the adsorption separation process as discussed later in this section.

In one example C8 and heavier aromatics are withdrawn as a bottoms stream in conduit 116 while toluene and lighter hydrocarbons recovered overhead via conduit 118 are sent to extractive distillation process unit 120 which separates a largely aliphatic raffinate in conduit 121 from a benzene-toluene aromatics stream in conduit 122. The aromatics stream in conduit 122 is separated, along with stripped transalkylation product in conduit 145 and overhead from para-xylene finishing column in conduit 157, in fractionator 123 into a benzene stream in conduit 124 and a toluene-and-heavier aromatics stream in conduit 125 which is sent to a toluene column 126. Toluene is recovered overhead from this column in conduit 127 and may be sent partially or totally to a transalkylation unit 140 as shown and discussed hereinafter.

A bottoms stream from the toluene column 126 is passed via conduit 128, along with bottoms from the reformate splitter in conduit 116, after treating via clay treater 117, and a purge stream of heavy aromatics in conduit 138, to low-pressure first xylene column 130. The feed stream to this column is characterized as a higher-boiling feed stream, as it generally contains more than about 5 weight-% C9+ aromatics and often more than about 10 weight-% C9+ aromatics. Other C8-aromatics streams having significant contents of C9 and heavier aromatics, including streams obtained from sources outside the complex, also may be added to this higher-boiling feed stream; a portion of deheptanizer bottoms in stream 165 also may be included depending on overall energy balances. The low-pressure xylene column separates concentrated first C8-aromatics stream as overhead in conduit 131 from a high-boiling first C9-and-heavier stream comprising C9, C10 and heavier aromatics as a bottoms stream in conduit 132.

Simultaneously, an isomerized C8-aromatics stream is passed via conduit 165 to a high-pressure second xylene column 133. This is characterized as a lower-boiling feed stream which contains a lower concentration of heavy materials subject to decomposition than the feed to column 130, and the second column pressure thus can be increased in order to effect energy savings. Other C8-aromatics-containing streams having similarly low contents of C9-and-heavier aromatics, including streams obtained from sources outside the complex, also may be contained in the feed stream to this column. The second xylene column separates a second C8-aromatics stream as overhead in conduit 134 from a second C9-and-heavier stream in conduit 132. At least a portion of overhead vapor from the high-pressure xylene column in conduit 134 preferably is employed to reboil low-pressure xylene column 130 in reboiler 135, leaving as a condensed liquid to the xylene-separation process 150 in conduit 136 as well as reflux (not shown) to column 133. In addition, the overhead in conduit 134 may be used to provide energy to the reboiler of extract column 152 or other such services which are described later or will be apparent to the skilled routineer.

The C9+ bottoms stream passing to reboiler 137 may provide energy via one or both of the stream before the reboiler in conduit 270 and the heated stream from the reboiler in conduit 259 for reboiling respectively one or both of heavy-aromatics column 170 and raffinate column 159; the bottoms stream after heat exchange would be sent to the heavy-aromatics column 170. Other similar heat-exchange services will be apparent to the skilled routineer. The net bottoms stream in conduit 138 usually is passed through column 130 or may be in conduit 139 combined directly with the stream in conduit 132 to heavies column 170. The heavies column provides an overhead a stream in conduit 171 containing C9 and at least some of the C10 aromatics, with higher boiling compounds, primarily C11 and higher alkylaromatics, being withdrawn as a bottoms stream via conduit 172. This column may be reboiled by xylene column bottoms in conduit 270, as discussed above. Overhead vapor from columns 130 and 170 also may generate steam respectively via conduits 230 and 271 as indicated, with condensed liquids either serving as reflux to each column or as net overhead respectively in streams 131 or 171.

The C9+ aromatics from heavies column in conduit 171 is combined with the toluene-containing overhead contained in conduit 127 as feed to transalkylation reactor 140 to produce a transalkylation product containing xylenes. The transalkylation product in conduit 141 is stripped in stripper 142 to remove gases in conduit 143 and C7 and lighter liquids which are returned via conduit 144 to extractive distillation 120 for recovery of light aromatics following stabilization in isomerate stripper 166. Bottoms from the stripper are sent in conduit 145 to benzene column 123 to recover benzene product and unconverted toluene.

The first and second C8-aromatics streams provided by xylene columns 130 and 133, containing para-xylene, meta-xylene, ortho-xylene and ethylbenzene, pass via conduit 131 and 136 to xylene-isomer separation process 150. The description herein may be applicable to the recovery of one or more xylene isomers other than para-xylene; however, the description is presented for para-xylene for ease of understanding. The separation process occurs in adsorption separation unit 150, which operates via a moving-bed adsorption process to provide a first mixture of para-xylene and desorbent via conduit 151 to extract column 152, which separates para-xylene via conduit 153 from returned desorbent in conduit 154. In one approach, the adsorption separation unit is a simulated countercurrent adsorption separation unit 150 as described further below.

By one approach, extract column 152 preferably is operated at an elevated pressure, at least about 300 kPa and more preferably about 500 kPa or higher, such that the overhead from the column is at sufficient pressure and temperature to reboil finishing column 155 via conduit 256 or deheptanizer 164 via conduit 265. Heat supplied for reboiling duty via conduits 256 and 265 results in the condensation of the extract in these streams which is either or both refluxed to column 152 (not shown) or sent as a net stream in conduit 153 to finishing column 155. The para-xylene is purified in finishing column 155, yielding a para-xylene product via conduit 156 and light material which is returned to benzene column 123 via conduit 157.

A second mixture of raffinate, as a non-equilibrium blend of C8 aromatics, and desorbent from separation process 150 is sent via conduit 158 to raffinate column 159, which separates a raffinate to isomerization in conduit 160 from returned desorbent in conduit 161. The raffinate column may be operated at higher pressure to generate steam via conduit 260 or to exchange heat in other areas of the complex; condensed liquids from such heat exchange either serve as reflux to the raffinate column or as net overhead in conduit 160. In one approach, the raffinate column is operated at an elevated pressure of at least about 300 kPa and more preferably about 500 kPa or higher. Recovered desorbent in conduits 154 and 161 and net finishing column bottoms may heat the incoming feed stream in conduit 110 via conduits 213 and 212, respectively.

The raffinate, comprising a non-equilibrium blend of xylene isomers and ethylbenzene, is sent via conduit 160 to isomerization reactor 162. In the isomerization reactor 162, raffinate is isomerized to provide a product approaching equilibrium concentrations of C8-aromatic isomers. The product is passed via conduit 163 to deheptanizer 164, which removes C7 and lighter hydrocarbons and preferably is reboiled using overhead in conduit 265 from extract column 152. Bottoms from the deheptanizer passes via conduit 165 to xylene column 133 to separate C9 and heavier materials from the isomerized C8-aromatics. Overhead liquid from deheptanizer 164 is sent to stripper 166, which separates light materials overhead in conduit 167 from C6 and C7 materials which are sent via conduit 168 to the extractive distillation unit 120 for recovery and purification of benzene and toluene values. Pressures of deheptanizer 164 and stripper 166 are selected to exchange heat or generate steam in a manner analogous to the xylene columns discussed elsewhere in this specification.

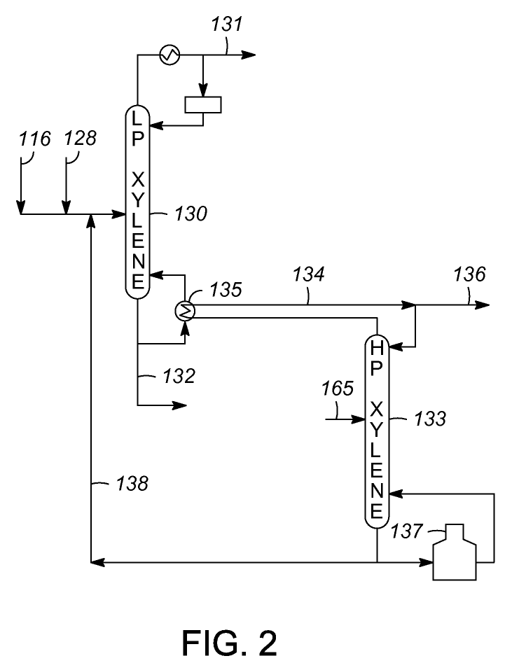

FIG. 2 shows in more detail the heat exchange of the invention between parallel xylene distillation columns 130 and 133. Feed to the low-pressure xylene column 130 comprises bottoms from the toluene column via conduit 128, clay-treated bottoms from the reformate splitter in conduit 116, and purge C8 aromatics in conduit 138 and may comprise other C8-aromatics-containing streams not suitable for processing in the high-pressure xylene column as well as a portion of the deheptanized stream 165 if appropriate for energy balances. The combined feeds of heavy reformate and toluene-column bottoms may contain heavy aromatics which are susceptible to degradation at high temperatures, and operating at a pressure lower than 800 kPa permits temperatures to be maintained in the bottom of the column and reboiler which avoid such decomposition. The low-pressure xylene column separates concentrated C8 aromatics as overhead in conduit 131 from a high-boiling stream comprising C9, C10 and heavier aromatics as a bottoms stream in conduit 132. The overhead stream from column 130 may be used at least partially via conduit 230 of FIG. 1 to generate steam or reboil other columns as discussed previously and thus be condensed to provide reflux to the column as well as the net overhead to xylene separation in conduit 131.

Simultaneously, an isomerized C8-aromatics stream is passed via conduit 165 to high-pressure xylene column 133; this stream contains a lower concentration of heavy materials subject to decomposition than the feed to column 130; the column pressure is elevated with respect to that of the low-pressure xylene column according to the invention, as discussed previously, in order to effect energy savings through concomitantly higher temperatures which may be employed to exchange heat at useful levels. The temperature of the overhead vapor from the high-pressure xylene column 133 therefore is sufficient to provide useful energy to other services in an aromatics complex. As shown, the temperature of the overhead vapor is sufficient to reboil the low-pressure xylene column 130 in reboiler 135, providing reflux to column 133 and a net stream in conduit 136. A small net bottoms stream in conduit 138 preferably is sent to low-pressure column 130 for recovery of remaining C8 aromatics.

Alternatively or in addition, the temperature of overhead vapor from high-pressure xylene column 133 is sufficient to generate steam useful for heating services or to reboil columns in other processing units. Such steam is generated usually at a pressure of in excess of about 300 kPa, preferably at least about 500 kPa, and most preferably about 1000 kPa or higher. The overhead stream may be indirectly heat exchanged with a water circuit which feeds a steam drum. Most usually, boiler feed water is heated in heat exchangers decoupled from the steam drum. Multiple water circuits serving different exchangers are arranged in parallel with each other and feed a single steam drum to provide a steam product of a desired pressure for which only one set of instrumentation is needed. Such steam systems are well known, and details can be added through such teachings as found in U.S. Pat. No. 7,730,854 which is incorporated herein by reference.

Energy recovery according to the present invention, often involving close temperature approaches between process fluids, is improved through the use of exchangers having enhanced nucleate boiling surface. Such enhanced boiling surface can be effected in a variety of ways as described, for example, in U.S. Pat. Nos. 3,384,154, 3,821,018, 4,064,914, 4,060,125, 3,906,604, 4,216,826, 3,454,081, 4,769,511 and 5,091,075, all of which are incorporated herein by reference. Such high-flux tubing is particularly suitable for the exchange of heat between the overhead of the second high-pressure xylene column and the reboiler of the first low-pressure xylene column or for the generation of steam from the xylene-column overhead.

Typically, these enhanced nucleate boiling surfaces are incorporated on the tubes of a shell-and-tube type heat exchanger. These enhanced tubes are made in a variety of different ways which are well known to those skilled in the art. For example, such tubes may comprise annular or spiral cavities extending along the tube surface made by mechanical working of the tube. Alternately, fins may be provided on the surface. In addition the tubes may be scored to provide ribs, grooves, a porous layer and the like.

Generally, the more efficient enhanced tubes are those having a porous layer on the boiling side of the tube. The porous layer can be provided in a number of different ways well known to those skilled in the art. The most efficient of these porous surfaces have what are termed reentrant cavities that trap vapors in cavities of the layer through restricted cavity openings. In one such method, as described in U.S. Pat. No. 4,064,914, the porous boiling layer is bonded to one side of a thermally conductive wall. An essential characteristic of the porous surface layer is the interconnected pores of capillary size, some of which communicate with the outer surface. Liquid to be boiled enters the subsurface cavities through the outer pores and subsurface interconnecting pores, and is heated by the metal forming the walls of the cavities. At least part of the liquid is vaporized within the cavity and resulting bubbles grow against the cavity walls. A part thereof eventually emerges from the cavity through the outer pores and then rises through the liquid film over the porous layer for disengagement into the gas space over the liquid film. Additional liquid flows into the cavity from the interconnecting pores and the mechanism is continuously repeated. Such an enhanced tube containing a porous boiling layer is commercially available under the trade name High Flux Tubing made by UOP, Des Plaines, Ill.

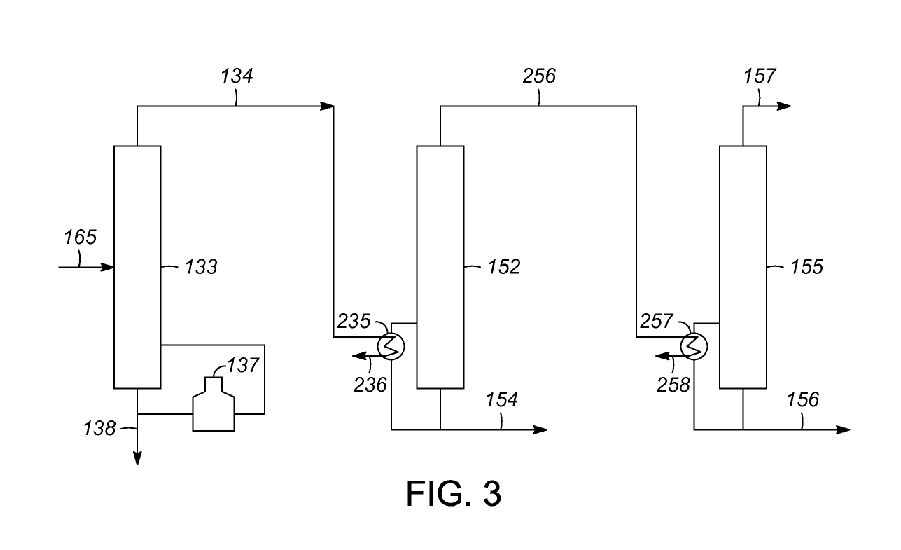

FIG. 3 illustrates examples of specific units within an aromatics complex in which direct heat exchange of overhead from one or more higher-temperature columns to reboilers of one or more lower-temperature columns could achieve energy savings, using numerical designations of processes from FIG. 1. Overhead in conduit 134 from the high-pressure xylene column 133 has a temperature sufficient to provide energy to reboil extract column 152 via reboiler 235, condensing the xylene overhead in conduit 236 for return to 133 as reflux or net overhead. The extract column may be pressurized such that overhead in conduit 256 has a sufficient temperature to reboil finishing column 155 via reboiler 257, condensing extract column overhead in conduit 258. As before, the product para-xylene is recovered in conduit 156.

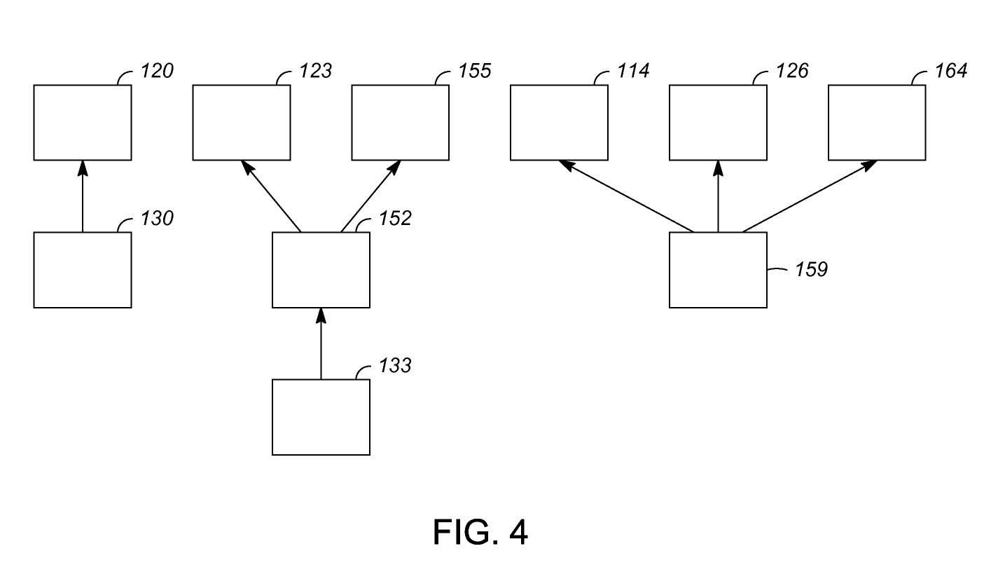

FIG. 4 summarizes a number, not exhaustive or exclusive, of direct heat-exchange possibilities related to FIG. 1. High-pressure xylene column 133 may provide heat to reboil one or more of low-pressure xylene column 130, extract column 152, and raffinate column 159. The low-pressure xylene column 130 may provide heat to reboil extractive distillation column 120. A pressurized extract column 152 may provide heat to reboil one or more of benzene column 123 and finishing column 155. A pressurized raffinate column 159 may provide heat to reboil one or more of reformate splitter 114, toluene column 126, and deheptanizer 164.

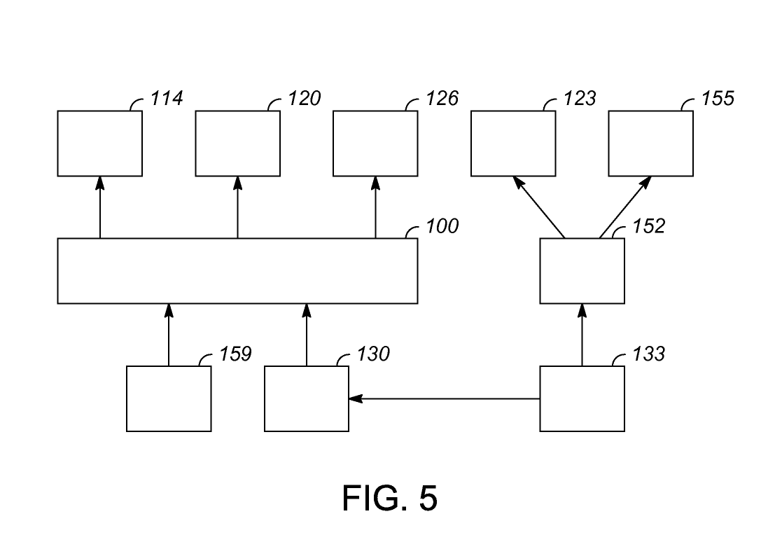

FIG. 5 summarizes nonexhaustive examples of indirect heat-exchange possibilities through the generation of medium-pressure steam. Overhead streams 230 (FIG. 1) from the low-pressure xylene column 130 and 260 (FIG. 1) from the pressurized raffinate column 159 may generate medium-pressure steam in header 100 at 0.6 to 2 MPa, and preferably 0.7 to 1.5 MPa which can be used to reboil one or more of reformate splitter 114, extractive distillation column 120 and toluene column 126 with the added potential of exporting steam to other units. Such generation and usage of steam can be considered as a supplement or substitute for other energy savings such as those described in FIG. 4. For example, the high-pressure xylene column 133 may provide heat to reboil the low-pressure xylene column 130 and extract column 152, which in turn reboils the benzene column 123 and finishing column 155.

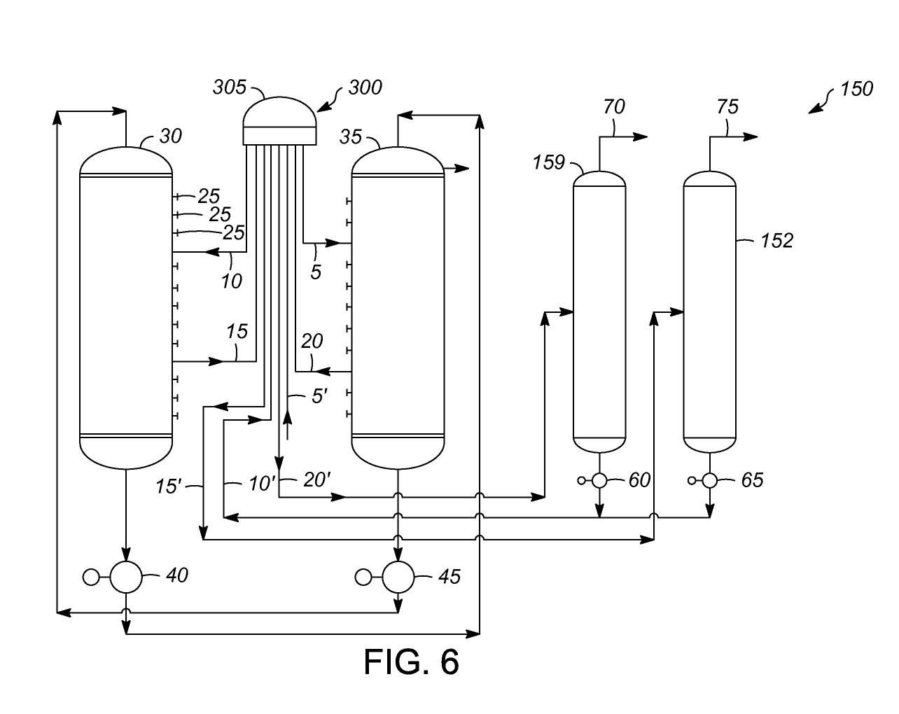

As mentioned previously, systems and apparatus in accordance with the invention include at least one adsorption separation unit 150 for separating para-xylene. FIG. 6 illustrates a simplified traditional adsorption separation unit within the aromatics recovery process flow scheme of FIG. 1, shown with extract and raffinate fractionation columns.

In one approach, the adsorption separation unit 150 simulates countercurrent movement of the adsorbent and surrounding liquid, but it may also be practiced in a cocurrent continuous process, like that disclosed in U.S. Pat. Nos. 4,402,832 and 4,478,721. The functions and properties of adsorbents and desorbents in the chromatographic separation of liquid components are well-known, and reference may be made to U.S. Pat. No. 4,642,397, which is incorporated herein, for additional description of these adsorption fundamentals. Countercurrent moving-bed or simulated-moving-bed countercurrent flow systems have a much greater separation efficiency for such separations than fixed-bed systems, as adsorption and desorption operations are continuously taking place with a continuous feed stream and continuous production of extract and raffinate. A thorough explanation of simulated-moving-bed processes is given in the Adsorptive Separation section of the Kirk-Othmer Encyclopedia of Chemical Technology at page 563.

The adsorption separation process of unit 150 sequentially contacts a feed stream 5 with adsorbent contained in the vessels and a desorbent stream 10 to separate an extract stream 15 and a raffinate stream 20. In the simulated-moving-bed countercurrent flow system, progressive shifting of multiple liquid feed and product access points or ports 25 down an adsorbent chamber 30 and 35 simulate the upward movement of adsorbent contained in the chamber. The adsorbent in a simulated-moving-bed adsorption process is contained in multiple beds in one or more vessels or chambers; two chambers 30 and 35 in series are shown in FIG. 6, although a single chamber or other numbers of chambers in series may be used. Each vessel 30 and 35 contains multiple beds of adsorbent in processing spaces. Each of the vessels has a number of ports 25 relating to the number of beds of adsorbent, and the position of the feed stream 5, desorbent stream 10, extract stream 15 and raffinate stream 20 are shifted along the ports 25 to simulate a moving adsorbent bed. Circulating liquid comprising desorbent, extract and raffinate circulates through the chambers through pumps 40 and 45, respectively. Systems to control the flow of circulating liquid are described in U.S. Pat. No. 5,595,665, but the particulars of such systems are not essential to the present invention. A rotary disc type valve 300, as characterized for example in U.S. Pat. Nos. 3,040,777 and 3,422,848, effects the shifting of the streams along the adsorbent chamber to simulate countercurrent flow. Although the rotary disc valve 300 is described herein, other systems and apparatus for shifting the streams along the adsorbent chamber are also contemplated herein, including systems utilizing multiple valves to control the flow of the streams to and from the adsorbent chamber 30 and/or 35 as for example, described in U.S. Pat. No. 6,149,874.

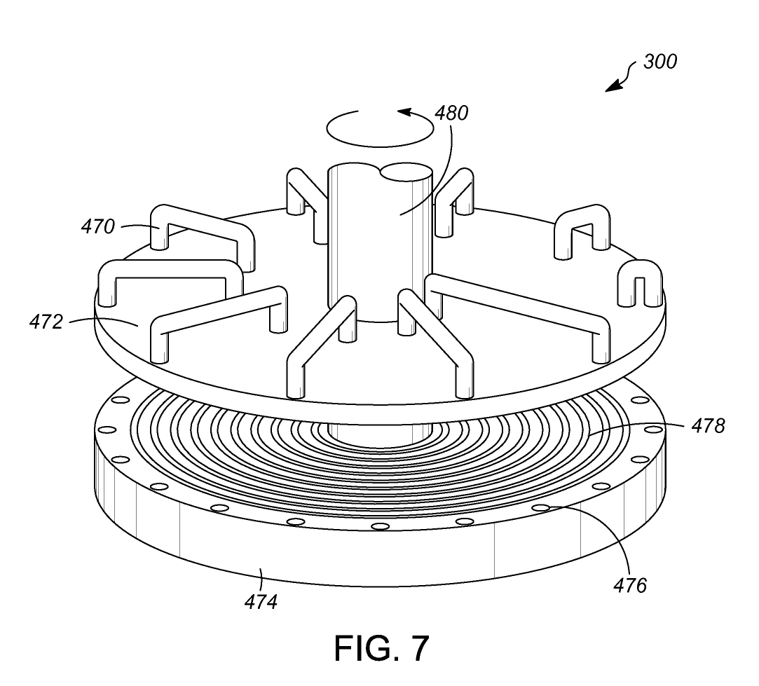

Referring to FIG. 7, a simplified exploded diagram of an exemplary rotary valve 300 for use in an adsorptive separation system and process is depicted. A base plate 474 includes a number of ports 476. The number of ports 476 equal the total number of transfer lines on the chamber(s). The base plate 474 also includes a number of tracks 478. The number of tracks 478 equal the number of net input, output, and flush lines for the adsorptive separation unit (not shown in FIG. 7). The net inputs, outputs, and flush lines are each in fluid communication with a dedicated track 478. Crossover lines 470 place a given track 478 in fluid communication with a given port 476. In one example, the net inputs include a feed input and a desorbent input, the net outputs include an extract output and a raffinate output, and the flush lines include between about one and about four flush lines. As the rotor 480 rotates as indicated each track 478 is placed in fluid communication with the next successive port 476 by crossover line 470. A seal sheet 472 is also provided for sealing the streams within the rotary valve 300 during operation as the rotary valve rotates in a stepwise fashion moving the transfer lines 470 to different ports 476. The rotary valve also includes a head 305 illustrated in FIG. 6 that encloses the rotary valve. The head 305 is pressurized in order to maintain the seal sheet 472 against the base plate 474. As mentioned previously, it has been found that operating the adsorption separation unit at higher pressures requires the pressure within the head 305 to also be operated at higher pressures leading to early degradation of the seal sheet 472.

Adsorption conditions in general include a temperature range of from about 20° to about 250° C., with from about 60° to about 200° C. being preferred for para-xylene separation. Adsorption conditions also include a pressure sufficient to maintain liquid phase, which may be from about atmospheric to 2 MPa. Desorption conditions generally include the same range of temperatures and pressure as used for adsorption conditions. Different conditions may be preferred for other extract compounds.

The various streams involved in simulated-moving-bed adsorption as illustrated in the figures and discussed further below with regard to the various aspects of the invention described herein may be characterized as follows. A “feed stream” is a mixture containing one or more extract components or preferentially adsorbed components and one or more raffinate components or non-preferentially adsorbed components to be separated by the process. The “extract stream” comprises the extract component, usually the desired product, which is more selectively or preferentially adsorbed by the adsorbent. The “raffinate stream” comprises one or more raffinate components which are less selectively adsorbed or non-preferentially adsorbed. “Desorbent” refers to a material capable of desorbing an extract component, which generally is inert to the components of the feed stream and easily separable from both the extract and the raffinate, for example, via distillation.

The extract stream 15 and raffinate stream 20 in the illustrated schemes contain desorbent in concentrations relative to the respective product from the process of between 0% and 100%. The desorbent generally is separated from raffinate and extract components by conventional fractionation in, respectively, raffinate column 159 and extract column 152 as illustrated in FIG. 6 and recycled to a stream 10′ by raffinate column bottoms pump 60 and extract column bottoms pump 65 to be returned to the process. FIG. 6 shows the desorbent as bottoms from the respective column, however in some applications the desorbent may be separated at a different location along the fractionation columns 152 and 159. The raffinate product 70 and extract product 75 from the process are recovered from the raffinate stream and the extract stream in the respective columns 159 and 152; the extract product 75 from the separation of C₈ aromatics usually comprises principally one or both of para-xylene and meta-xylene, with the raffinate product 70 being principally non-adsorbed C₈ aromatics.

The extract and raffinate flows from the adsorptive separation unit are important in the operation of the adsorption separation process. Specifically, the adsorption separation relies on achieving a compositional profile within the adsorption separation chamber between the different components within the chamber, including at least the preferentially adsorbed component, the one or more non-preferentially adsorbed components, and the desorbent. The compositional profile shifts along the chamber(s) with the shifting feed and recovered streams during operation of the adsorption separation unit 150. The extract and raffinate streams are withdrawn from the chamber at different ports 25 depending on the compositional profile at the particular port in order to achieve high purity streams. For example, an extract stream is drawn off of the adsorption separation chamber 30 and 35 from a location along the chamber where the composition of the fluid includes a high amount of the preferentially adsorbed component and a low amount of the non-preferentially adsorbed component. The system has traditionally relied on passive means, i.e., a pressure difference between the adsorption separation unit 150 and downstream fractionation columns 159 and 152 in order to achieve flow of the extract and raffinate streams away from the adsorption separation unit 150 to avoid problems in achieving product purity if active means to generate and control flow were used that risked failure or malfunction. This has been considered important to the successful separation in the separation unit 150 because a backup of the extract and/or raffinate streams could change the flow patterns, and thus compositional profile, within the adsorption separation unit 150. This could potentially affect the throughput and product purity achieved by the system. Because many adsorption separation systems require high purities, this can detrimentally impact the business.

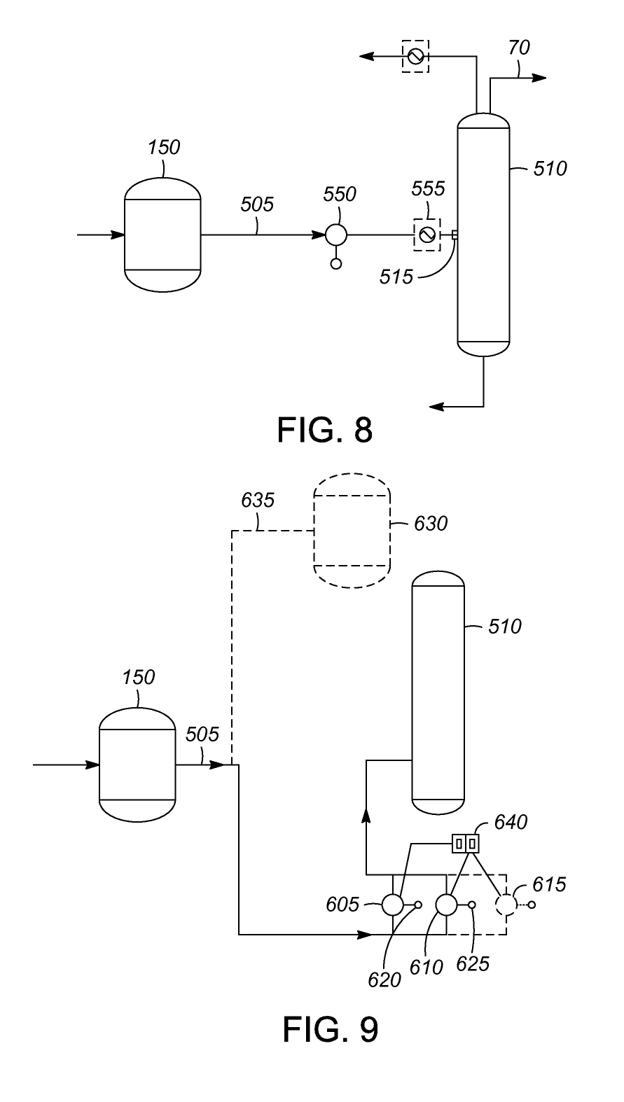

By one approach, a pump 550 is provided for pumping one of the extract stream and the raffinate stream from the adsorption separation unit 150 to the respective fractionation column. Turning to the schematic diagram of FIG. 8, a portion of the apparatus and process of one aspect of the invention is illustrated, showing adsorption separation unit 150 and a fractionation column 510. For ease of explanation, the apparatus and process will be described generically with regard to a fluid being transferred between the adsorption separation unit 150 and a fractionation column 510, however, it should be understood that the present invention may be applied with regard to one or both of the extract stream flowing through line 15′ to the extract fractionation column 152 and the raffinate stream flowing through line 20′ to the raffinate fractionation column 159. A conduit or line 505 is provided between the adsorption separation unit 150 and the fractionation column 510 for carrying the stream. In one approach, where the adsorption separation unit 150 includes a rotary valve 300, the line 505 is coupled between the rotary valve 300 and the fractionation column inlet 515 such that the extract stream is transferred via the line 505 between the extract stream line of the rotary valve 300 and the column inlet 515. It should be understood that the line 505 may include one or more lines or conduits in fluid communication between the adsorption separation unit 150 and the fractionation column 510. It should also be understood that the fractionation column 510 can include one or more fractionation columns positioned in series or in parallel. In addition, additional equipment or apparatuses may be positioned along the line 505 while remaining within the scope of the invention. For example, one or more heat exchangers or reboilers 555 may be located along the line 505 for increasing the temperature of the stream entering the fractionation column 510 as illustrated in FIG. 8 or for transferring heat to or from the stream.

In one approach, as mentioned previously, the fractionation column 510 is operated at an elevated pressure compared with traditional systems in order to provide for the energy conservation. In one approach, due to the elevated internal pressure of the fractionation column 510, the pressure at the fractionation column inlet 515 is elevated such that the streams from the adsorption section will not flow, or will not flow with a sufficient flowrate, into the fractionation column. The operating pressure at the adsorption section would have to be higher than the sum of the pressure at the fractionation column inlet 515 and the pressure drop along line 505. The pressure drop along the line 505 typically occurs due to friction between the fluid stream and the walls, pipes, tubing, valves, and other equipment along the line or conduit 505, like for example heat exchangers or reboilers 555 located along the line 505. It should be understood that the stream will always flow in the direction of higher to lower pressure. A lower pressure in the adsorption section relative to the pressure at column inlet 515 means that the flow of liquid in line 505 would be in the reverse direction. Lower pressure would not be able to drive the flow of the stream from the adsorption separation unit 150 into the fractionation column 510. This would include the fractionation column 510 operating at a higher pressure than one or more positions along the transfer line 505, including the inlet 515, as a result of the stream undergoing a pressure drop as it travels through line 505. This could also occur where the fractionation column 510 is operating at a higher pressure than the adsorption separation unit 150, including the chamber(s) 30 and 35.

Turning to more of the particulars, the fractionation column 510 may have an operating pressure of between about atmospheric pressure to about 2 MPa. In one example, the fractionation column 510 has an operating pressure above about 300 kPa. In another example, the fractionation column 510 has an operating pressure above about 500 kPa. In yet another example, the fractionation column 510 has an operating pressure between about 550 kPa and about 2 MPa. In yet another example, the fractionation column 510 has an operating pressure between about 550 kPa and about 600 kPa.

Adsorption conditions within the adsorption separation unit 150 include a pressure sufficient to maintain liquid phase, which may be from about atmospheric to 2 MPa. In another example, the adsorption separation unit has an operating pressure of between about 800 kPa and about 1100 kPa. In yet another example, the adsorption separation unit has an operating pressure of between about 850 kPa and about 900 kPa. In one approach, the pressure drop between the adsorption separation chambers 30 and 35 and the fractionation column 510 is between about 600 and 800 kPa. In another approach, the pressure drop is between about 700 and 750 kPa. Thus, it has been identified that the pressure from the adsorption separation unit 150 is insufficient to provide flow of the stream into the fractionation column 510, because the sum of the pressure drop in line 505 and the inlet pressure 515 exceed the pressure at adsorption separation unit 150.

In one approach, in order to overcome the elevated pressure within the fractionation column 510 so that the stream flows through the line 505 between the adsorption separation chamber 150 and the fractionation column 510 a pump 550 is provided along extract stream line 505. The pump 550 is positioned along the line 505 between the adsorption separation chamber 150 and the fractionation column 510. The pump 550 essentially decouples the fractionation column 510 from the adsorption separation chamber 150 in order to overcome the difficulties of having the column 510 operating at a higher pressure. The pump 550 should provide sufficient head to overcome the pressure differential between the adsorption separation chamber and the fractionation column 510 along the line 505 in order to pump the stream into the fractionation column 510. In other words, the pump 550 should supply sufficient energy to the stream in line 505 to raise its pressure above the pressure of the downstream column. This is commonly referred to as pump head. Equipment elevations will impact static head between the fractionation column 510 and adsorption unit 150, which is also included in the pump head. In one approach, the pump 550 is installed to take suction directly from the adsorbent chambers 30 and 35. In this regard, in one approach, when the adsorption separation unit 150 includes a rotary valve 300, as illustrated in FIG. 6, the pump 550 is configured to take suction via the rotary valve 300, from the appropriate extract line or raffinate line depending on how the invention is carried out.

In one approach, the pump 550, which may include more than one pump, increases the stream pressure by about 50 kPa to about 2.5 MPa in order to pump the stream into the fractionation column. In another approach, the pump 550 increases the stream pressure by about 150-500 kPa. In another approach, the pump 550 increases the stream pressure by about 200-400 kPa. In yet another approach, the pump 550 increases the stream pressure by about 250-350 kPa.

As discussed above, it is important that the stream flows continuously through line 505 to the fractionation column 510. In this regard, the pump should remain on-stream at all times, so additional process controls may be needed. In one approach, the pump 550 includes more than one pump in order to restrict backflow of the stream or other interruptions in the flow of the stream in a downstream direction if one of the pumps fails or otherwise is not being operated. Backflow of the stream toward the adsorption separation chamber 150 or an interruption in the flow of the stream could otherwise decrease product purity and or throughput as mentioned previously. By this approach, the pumps are arranged in parallel. In addition, the more than one pump may be configured in various operating arrangements as described further hereafter to provide generally uninterrupted flow of the stream, even during malfunction or failure of a pump.

In accordance with one approach, one or more pumps along line 505 are primary pumps and one or more other pumps along line 505 are backup pumps in standby mode during normal operation. For example, referring to FIG. 9, where two pumps are utilized, a first pump 605 is a primary pump and a second pump 610 is a backup pump. The first primary pump 605 will typically operate to pump the fluid stream stream along the line 505 and into the fractionation column 510 during normal operation, while the second backup pump 610 may be configured to operate when the first pump is not operating or operating at reduced capacity. In this regard, the second pump 610 may be configured to turn on automatically when the first pump stops operating or to turn on manually prior to an operator shutting down the first pump 605. Alternatively, the first and second pumps 605 and 610 may alternate as the primary and secondary pumps even when the first pump does not fail, for example, to preserve the life of both pumps.

In another approach, two or more pumps may each provide a percentage of the total workload. Referring again to FIG. 9, both the first and second pumps 605 and 610 may serve as primary pumps with each pump operating at below 100% of the desired operating capacity to handle a portion of the flow. For example, the first and second pumps may each provide 50 percent of the total operating flow capacity. An optional third pump 615 may serve as a backup pump as described above with regard to the previous approach. The third pump 615 may begin operating when either the first pump 605 or the second pump 610 stops operating, and the third pump may provide the percentage of the capacity that had previously been provided by the no longer operating pump. In this manner, the pumping action of the primary pumps will not completely stop in the time between when one of the primary pumps 605 and 610 fails and the secondary pump 615 begins operating. As will be understood, in accordance with this approach, additional primary and backup pumps may be provided, with each providing a percentage of the total capacity.

According to various approaches, where the pump 550 includes more than one pump, each pump, for example 605 and 610 illustrated in FIG. 9, may include its own power supply 620 and 625 respectively. In this manner, if a failure to one of the power supplies 620 and 625 occurs during operation, so that one of the pumps 605 and 610 is not able to operate, the other power supply 620 or 625 may continue supplying power to the other pump 605 or 610 so that the stream may continue to be pumped to the fractionation column 510.

According to one aspect, one of the power supplies 625 may include an alternate power supply type that is different than the power supply type of the first power supply 620. For example, the second power supply 625 may be a steam-turbine driver. In this manner, if the first power supply 620 failed due to a power outage or other event, the second steam-turbine driver may continue to provide power to the second pump 610. A steam-driven pump approach would be most economical at an operating site where a surface condenser system exists for other process equipment and could be sized to accommodate an intermittent incremental load from the booster pump driver. Other types of alternate power supplies are also contemplated and could include for example a gas-turbine drive, an uninterruptible power from a battery or similar local energy storage device, or the facility electrical grid.

According to various approaches, the pump 550, including one or more pumps where more than one pump is included, may include a variable speed pump having variable speed drivers. In this manner, the pump 550 may be configured to handle the dynamic flow of the stream exiting the adsorption separation unit 150 without the need for control valves.

In this regard, the traditional control valve provided along the line 505 for controlling the amount of fluid flowing through the line 505 may be removed, and the speed of the variable speed pump can instead be adjusted to control the flowrate of the stream. Alternatively, the control valve may be included to control the flow of material between the adsorption separation unit 150 and the fractionation column 550. This could further provide economic advantages by reducing equipment and fabrication costs and maintenance required on the control valve.

A surge vessel 630 may also be provided and in fluid communication with the line 505. The surge vessel 630 is available to retain fluid from the line 505 in the event that the pump 550 fails for a period of time so that the stream is not able to flow into the fractionation column 510. Active or passive control may be provided for diverting at least a portion of the stream into the surge vessel 630. For example, a valve may be in a closed state during normal operation, but be opened to allow the stream to flow via a line 635 into the surge vessel 630 if the pump fails. Alternatively, for example, an increased amount of pressure within the line 505 due to fluid buildup may provide a driving force for diverting the flow of the stream through line 635 into the surge vessel. When pump operation is restored, the fluid retained in the surge vessel may be pumped or otherwise flow back into and through the line 505 and into the fractionation column 510.

According to various approaches, a control system 640 may be provided for controlling the pump 550, including one or more pumps as described above. Where more than one pump is used, as illustrated in FIG. 9, the control system 640 controls operation of each of the pumps 605 and 610. In one example, where the first pump is the primary pump and the second pump is the backup pump, the control system 640 may detect a failure of the first pump and initiate operation of the second pump to continue pumping the stream through line 505 and into the fractionation column 510. In this regard, the control system may include an automated auto-start functionality. Appropriate instrumentation and hardware, such as solenoid activated isolation valves, may be included to bring the second backup pump 610 on-line immediately in the event of a primary pump failure.

In accordance with the various approaches described above, a pump 550 may be provided for flowing a stream from the adsorption separation unit 150 to the fractionation column 510 even where the fractionation column is operating at elevated pressures, for example to provide energy savings or for other reasons. Through the inclusion of appropriate pump failure protection schemes, including for example spare pumps, surge vessels, alternate power supply sources and/or control systems, the risk of interruption to the continuous flow of the stream flowing from the adsorption separation unit 150 can be reduced to avoid interrupting operation of the adsorption separation unit 150.

By one approach, the fractionation column 510 illustrated in FIG. 9 is an extract fractionation column 152 as shown in FIGS. 1 and 6 and the line or conduit 505 carries the extract stream from the adsorption separation unit 150 to the extract fractionation column 152. By another approach, the fractionation column 510 illustrated in FIG. 9 is a raffinate fractionation column 159 as shown in FIGS. 1 and 6 and the line or conduit 505 carries the raffinate stream from the adsorption separation unit 150 to the extract fractionation column 159. Further, the inventions described herein can be applied to both the extract stream and the raffinate stream in a hydrocarbon conversion process such as those illustrated in FIGS. 1-6.

In accordance with one approach, a process is provided for separating one or more preferentially adsorbed components from a feed stream comprising the preferentially adsorbed component and one or more non-preferentially adsorbed component. The process includes separating the preferentially adsorbed component in an adsorptive separation process.

The process may include separating the preferentially adsorbed component using simulated countercurrent adsorptive separation in the adsorption separation unit. In one approach, the process includes transferring one of the extract stream and the raffinate stream from the adsorption separation unit to a fractionation column for separation of one or more components within the stream.

The process also includes operating the fractionation column at an elevated pressure. By one approach, the fractionation column is operated at a pressure such that the sum of the column inlet pressure and pressure drop in the transfer line and equipment between the adsorption section and the column is higher than the adsorption unit pressure. The process includes pumping the stream along a transfer line from the adsorption separation unit and into the fractionation column to overcome a pressure differential at one or more locations along the stream and the fractionation column. The process may include using a high pressure stream from the fractionation column for heating another stream, reboiler, column, or heat exchanger as described above.

In one approach the process includes transferring the extract stream from the adsorption separation unit to an extract fractionation column for separating an extract product. In this approach, the process includes pumping the extract stream into the extract fractionation column. In another approach, the process includes transferring the raffinate stream from the adsorption separation unit to the raffinate fractionation column for separating a raffinate product. In this approach, the process includes pumping the raffinate stream into the raffinate fractionation column.

Turning to more of the particulars, in selecting an adsorbent for the present simulated-moving-bed process, the only limitation is the effectiveness of the particular adsorbent/desorbent combination in the desired separation. An important characteristic of an adsorbent is the rate of exchange of the desorbent for the extract component of the feed mixture materials or, in other words, the relative rate of desorption of the extract component. This characteristic relates directly to the amount of desorbent material that must be employed in the process to recover the extract component from the adsorbent. Faster rates of exchange reduce the amount of desorbent material needed to remove the extract component, and therefore, permit a reduction in the operating cost of the process. With faster rates of exchange, less desorbent material has to be pumped through the process and separated from the extract stream for reuse in the process.

The practice of the subject invention thus is not related to or limited to the use of any particular adsorbent or adsorbent/desorbent combination, as differing sieve/desorbent combinations are used for different separations. The adsorbent may or may not be a zeolite. Examples of adsorbents which may be used in the process of this invention include nonzeolitic molecular sieves including carbon-based molecular sieves, silicalite and the crystalline aluminosilicates molecular sieves classified as X and Y zeolites. Details on the composition and synthesis of many of these microporous molecular sieves are provided in U.S. Pat. No. 4,793,984, which is incorporated herein for this teaching. Information on adsorbents may also be obtained from U.S. Pat. Nos. 4,385,994; 4,605,492; 4,310,440; and 4,440,871.

In adsorptive separation processes, which generally are operated continuously at substantially constant pressures and temperatures to insure liquid phase, the desorbent material must be selected to satisfy several criteria. First, the desorbent material should displace an extract component from the adsorbent with reasonable mass flow rates without itself being so strongly adsorbed as to unduly prevent an extract component from displacing the desorbent material in a following adsorption cycle. Expressed in terms of the selectivity, it is preferred that the adsorbent be more selective for all of the extract components with respect to a raffinate component than it is for the desorbent material with respect to a raffinate component. Secondly, desorbent materials must be compatible with the particular adsorbent and the particular feed mixture. More specifically, they must not reduce or destroy the capacity of the adsorbent or selectivity of the adsorbent for an extract component with respect to a raffinate component. Additionally, desorbent materials should not chemically react with or cause a chemical reaction of either an extract component or a raffinate component. Both the extract stream and the raffinate stream are typically removed from the adsorbent void volume in admixture with desorbent material and any chemical reaction involving a desorbent material and an extract component or a raffinate component or both would complicate or prevent product recovery. The desorbent should also be easily separated from the extract and raffinate components, as by fractionation. Finally, desorbent materials should be readily available and reasonable in cost. The desorbent may include a heavy or light desorbent depending on the particular application. The terms heavy and light are in reference to the boiling point of the desorbent relative to the C8 aromatics, namely, ortho-, meta-, para-xylene and ethylbenzene. Those skilled in the art will appreciate that the designator “C8” refers to a compound comprising eight (8) carbon atoms. In certain embodiments, the heavy desorbent is selected from the group consisting of para-diethylbenzene, para-diisopropylbenzene, tetralin, and the like, and combinations thereof In certain embodiments, toluene and the like can be used as the light desorbent. The para-diethylbenzene (p-DEB) has a higher boiling point than the C8 aromatic isomers and, as such, the p-DEB is the bottoms (i.e., heavy) product when separated from the C8 isomers in a fractional distillation column. Similarly, toluene has a lower boiling point than the C8 aromatic isomers and, as such, the toluene is the overhead (i.e., light) product when separated from the C8 isomers in a fractional distillation column. The p-DEB has become a commercial standard for use as a desorbent in separations of para-xylene.

The above description and examples are intended to be illustrative of the invention without limiting its scope. While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention.

### EXAMPLE

The use of a pump 550 for pumping a stream into the fractionation column 550 as described above with regard to FIGS. 8-9 was evaluated in terms of payback on investment. The base case is a facility as described in FIGS. 1 and 6, but not including a pump 550 as described above. The base case system instead operates at an operating pressure throughout the system, including within the adsorption separation unit 150 and chambers 30 and 35 in order to use a positive pressure differential between the adsorption separation unit 150 and the fractionation column 550 to provide the driving force for moving the stream into the fractionation column. Preliminary economic analysis of the invention indicates capital cost savings in vessel material of about $500,000 USD. Select exchangers in the affected pump circuits will also be cheaper due to lower mechanical design pressures. Net energy savings are estimated at about $50,000 annually. The cost of the pump or pumps is expected to be less than $100,000.

1. An apparatus for separating components in a feed stream by simulated countercurrent adsorptive separation comprising:
an adsorption separation unit having an adsorption separation unit operating pressure with ports for receiving a feed stream and a desorbent stream and ports for removal of an extract stream and a raffinate stream, the adsorption separation unit configured to receive the feed stream and to generate an extract stream, including at least one preferentially adsorbed component, and a raffinate stream, including at least one non-preferentially adsorbed component;
a fractionation column having a fractionation column operating pressure for separating desorbent from one of the extract stream and the raffinate stream to generate a product stream;
a line in fluid communication between the adsorption separation unit and the fractionation column for carrying one of the extract stream and the raffinate stream from the adsorption separation unit to the fractionation column and having a pressure loss that occurs along the line between the adsorption separation unit and the fractionation column, wherein the fractionation column operating pressure is greater than the adsorption separation unit operating pressure minus the pressure drop that occurs along the line; and
a pump along the line for pumping the one of the extract stream and the raffinate stream through the line and into the fractionation column.

2. The apparatus of claim 1, wherein the pump includes a primary pump that operates during normal operation and a backup pump that operates during an interruption in the operation of the primary pump.

3. The apparatus of claim 1, wherein the fractionation column includes an extract fractionation column and the pump moves the extract stream through the line and into the extract fractionation column.

4. The apparatus of claim 1, wherein the fractionation column includes a raffinate fractionation column and the pump moves the raffinate stream through the line and into the raffinate fractionation column.
